(19) United States
(12) Patent Application Publication
(10) Pub. No.: US 2007/0172659 A1
(43) Pub. Date: Jul. 26, 2007

(54) Anti-oxidation coating for carbon composites

(76) Inventor: Richard L. Shao, North Royalton, OH (US)

Correspondence Address: WADDEY & PATTERSON, P.C., 1600 DIVISION STREET, SUITE 500, NASHVILLE, TN, 37203, US

(21) Appl. No.: 11/340,370

(22) Filed: Jan. 26, 2006

(51) Int. Cl. B05D 3/02; B32B 9/00

(52) U.S. Cl. 428/408; 427/372.2; 428/698

(57) ABSTRACT

An oxidation-resistant carbon composite is formed from a protective coating applied over the surface of the carbon composite. The coating, itself, is formed through the application of a metal silicide containing medium to a carbon composite and subsequently heated to convert a portion of the metal silicide into silicon carbide and a metal carbide. The invention exhibits improved oxidation resistance especially in high temperature applications in the presence of oxidizing gases. Of particular interest is the application of the present invention for high friction disc brake systems for vehicles including aircraft.

### BACKGROUND OF THE INVENTION

The present application relates to a method for forming an anti-oxidation coating on carbon composite structures suitable for high temperature, friction-bearing applications. The present application also relates to the formed oxidation-resistant product and specific chemical composition utilized to preclude oxidation of a carbon composite structure. The novel coating also finds particular utility in conjunction with carbon/carbon composite materials as well as ceramic/carbon composite materials used as components of friction brake structures. The coating, itself, is formed through the application of a metal silicide containing medium to a carbon composite which is subsequently heated to convert a portion of the metal silicide into silicon carbide and a metal carbide. The anti-oxidation coating, the method of creating the anti-oxidation coating, and the coated carbon composite will be described with particular reference thereto.

Carbon/carbon composites include those structures formed from a fiber reinforcement, which itself consists primarily of carbon, and a carbon matrix derived from a thermoplastic binder, such as pitch, or a thermosettable resin, such as a phenolic resin. Such materials are useful in applications where high temperature frictional properties and high strength to weight ratios are important. For example, carbon/carbon composites are known to be effective for providing thermal barriers and friction-bearing components, particularly in aircraft, aerospace vehicles, and high performance road vehicles. Carbon/carbon composites have been used for forming brake pads, rotors, clutches, and structural components for these vehicles. They tend to exhibit good temperature stability (often up to about 3000° C., or higher), high temperature friction properties (typical coefficients of friction are in the range of 0.4-0.5 above 500-600° C.), high resistance to thermal shock, due in part to their low thermal expansion behavior, and lightness of weight. Thermal insulation materials formed from certain types of carbon fibers exhibit excellent resistance to heat flow, even at high temperatures.

Similarly, ceramic/carbon composites are desirable because of their exceptional high-temperature performance, relative lightness of weight, extreme hardness, and high wear resistance. As with carbon/carbon composites, ceramic/carbon composites are used as both brake discs and brake pads. These brake systems have high coefficients of friction and excellent friction characteristics across a wide range of operating temperatures. Typical coefficients of friction for carbon fiber reinforced ceramic brake pads are in the range between 0.5 and 0.9, under JIS D4411 test conditions.

A common problem with carbon composites is the decomposition of the carbon composite under certain atmospheric conditions. Carbon composites are highly oxidizable and will oxidize to carbonaceous gases when exposed to elevated temperatures in the presence of an oxidizing gas. Specifically, at temperatures above about 500° C., carbon will react with oxygen to form carbon dioxide and/or carbon monoxide. When carbon composites are used in disc brake systems, the carbon composite will have to absorb a substantial amount of kinetic energy to slow the vehicle down. During this slow down, the composite can be heated to a high enough temperature to cause oxidation of the carbon composite. Such exposure results in the carbon composites having to be frequently replaced.

To reduce the oxidation of carbon composites and thereby increase the composite's lifespan, a variety of coating systems have been developed to protect the carbon composite from oxidation.

Wilson, in U.S. Pat. No. 4,439,491, describes the treatment of graphite or carbon products with a solution comprising mono-ammonium phosphate, zinc orthophosphate, phosphoric acid, boric acid, cupric oxide and a wetting agent in water to protect against oxidation.

Chapman et al. (U.S. Pat. No. 4,711,666) discloses the use of a binder/suspension with the liquid phase being a colloidal silica solution, monoaluminum phosphate, and ethanol and the solid elements being boric acid and silicon carbide for oxidation protection.

In U.S. Pat. No. 4,893,286, Gray describes a composite structure coated with a moieties of silicon, titanium and also boron, applied through chemical vapor deposition. Upon exposure to high temperatures the silicon moiety is expected to experience microcracks and permit oxidation of the titanium, boron and silicon while precluding the oxidation of the carbon composite.

Weir et al. (U.S. Pat. No. 4,931,413) claims a glass ceramic precursor of titanium diboride and a silica compound which upon heating, creates a sealant for use in harsh atmospheres.

Sugizaki et al. (U.S. Pat. No. 5,882,778) describes a multilayered coating system where the first coating is comprised of a metallic element such as aluminum or titanium and also a non-metallic element such as nitrogen and where the second coating is a lamination of aluminum boron nitride on the surface.

Gray, in U.S. Pat. No. 6,668,984, discloses an oxidatively resistant coating for carbon materials comprising two distinct coatings with the first coating being silicon or silicon carbide and the second coating comprising a material containing phosphorous.

A disadvantage of the prior art is the difficulty in applying the protective coating to the carbon article. Chemical vapor deposition is extremely expensive while multi-layer systems necessitate more detailed design parameters. Additionally, a fundamental cause for the failure of prior art coating systems is the relatively low thermal expansion of the substrate relative to the coating. When the tensile strain on the coating becomes excessive, cracks develop, rendering the protective coating ineffective. Furthermore, penetrant style oxidation protection systems require a necessary internal porosity of the carbon composite for the penetrant to provide oxidation protection. Also, prior art coatings often lack durability for use in high-friction applications, and can significantly alter the carbon composite's coefficient of friction resulting in an inferior braking system.

What is desired, therefore, is an oxidation resistant carbon composite which is durable, provides oxidation protection, and with the coating being easy to apply. Additionally, a cost effective method of providing oxidation protection is needed where application is less tedious and additives are easily incorporated into the protective coating. Furthermore, a coating system to achieve oxidation resistant carbon composites is desirable where the coating system can be tailored to the specific environmental conditions in which the carbon composite will be exposed. Indeed, a combination of characteristics, including strength and durability, similar coefficients of thermal expansion to carbon composites, ease of application, and modifiable properties have been found to be necessary for oxidation coatings for carbon composites. Also desired are oxidation resistant carbon composites and methods for coating carbon composites with an oxidation protective coating.

### SUMMARY OF THE INVENTION

In accordance with one aspect of the present invention, a method of forming an oxidation resistant coating upon a carbon composite material is provided. The method includes applying a metal silicide containing slurry to the surface of a carbon composite material and subsequently heating the slurry coated carbon composite to convert the slurry coating into an oxidation resistant coating upon the carbon composite. The formed oxidation coating provides oxidation protection up to about 1800° C. with typical operating temperatures of from about 800° C. to about 1300° C.

More particularly, the metal silicide in the slurry coating is titanium disilicide which upon heating can covert to titanium carbide, silicon carbide and titanium silicon carbide. Typically, heating the slurry coated carbon composite of from about 1200° C. to about 1800° C. is sufficient to convert the titanium disilicide into various carbides.

An object of the invention, therefore is an oxidation resistant carbon composite material having a coating which enables it to be employed in high temperature application in the presence of oxidizing gases.

Another object of the invention is a method of creating the oxidation resistant carbon composite material by coating the carbon composite with a metal silicide and subsequently converting the metal silicide into a carbide coating.

Still another object of the invention is an oxidation protective coating system in which the starting slurry components can be tailored for the specific environmental stresses to which the coated carbon composite will be subjected.

These aspects and others that will become apparent to the artisan upon review of the following description can be accomplished by providing a carbon composite coated with the metal silicide slurry and heating the coated carbon composite to convert the metal silicide into a protective carbide coating.

It is to be understood that both the foregoing general description and the following detailed description provided embodiments of the invention and are intended to provide an overview or framework of understanding to nature and character of the invention as it is claimed.

### DETAILED DESCRIPTION OF THE INVENTION

Both ceramic/carbon composites and carbon/carbon composites are extremely unreactive materials providing beneficial properties, even at high temperatures. Synthetic graphite, for example, exhibits excellent stability in non-oxidizing atmospheres up to about 3000° C. However, these composites can readily oxidize at high temperatures resulting in severe deterioration of the carbonaceous material. With graphite having an oxidation threshold of from about 500° C. to about 550° C., many uses for carbon composites are limited because of their susceptibility to oxidation. By either precluding or even slowing the rate of oxidation, carbon composites could be utilized in a wider variety of applications as an oxidation resistant carbon composite would maintain both physical strength and structural integrity much longer.

One such area where an improved oxidation resistant coating would be useful is in the high-friction braking system industry. A variety of high-friction braking systems utilizes carbon composite discs to absorb large amounts of kinetic energy as the vehicle is slowed down. Specifically, commercial aircraft brakes operate at temperatures of from about 500° C. to about 700° C. though may approach higher temperatures in certain instances. Furthermore, military aircraft routinely see temperatures significantly higher, with temperatures of about 1500° C. being experienced for extended periods of time. The temperatures achieved by military aircraft as well as commercial aircraft are more than sufficient to cause degradation in the carbon composite brake component resulting in frequent replacement and a reduced life span of the composite component. As such, the utilization of this invention allows for a longer lifespan of the composite component while maintaining desirable friction and thermal properties through the use of a coating which reduces oxidation of the underlying carbon composite.

Oxidation resistant carbon composites are prepared by applying a coating to a carbon composite material. Most often, the carbon composite material is either a ceramic/carbon composite or a carbon/carbon composite. A method of forming a carbon/ceramic composite material suitable for use in thermal structural applications, such as friction components, is provided through the combination of a pre-ceramic polymer and carbon-containing fibers. The pre-ceramic polymer and carbon-containing fibers mixture is then heat-treated so that the pre-ceramic polymer is pyrolytically decomposed. Thus the pre-ceramic polymer forms a fully ceramic, amorphous silicon carbide with minimal shrinkage of the composite body.

Carbon/carbon composites include those structures formed from a fiber reinforcement, which itself consists primarily of carbon, and a carbon matrix derived from a thermoplastic binder, such as pitch, or a thermosettable resin, such as phenolic resin. Methods of creating carbon/carbon composites are described in published U.S. patent application Ser. No. 10/720,833, the disclosure of which is incorporated herein by reference. One common method of creating carbon/carbon composites begins with lay-up of a woven fiber fabric or pressing a mixture of carbonized fibers derived from pitch (e.g., mesophase pitch or isotropic pitch), cotton, polyacrylonitrile, or rayon fibers, and the fusible binder. In this process, the fibers are first impregnated with resin to form what is commonly known as a prepreg and the prepreg is layered in the mold of a heated press. The prepreg is then compressed and heated to fully cure the resin. The fiber and cured resin composite is then heated at a slow rate in a separate operation to convert the binder to carbon, thus forming the carbon/carbon composite.

Both the ceramic/carbon composite and also the carbon/carbon composite can be readily formed in the shape of a brake disc, a brake pad or even a rectangular block, for use in high temperature friction braking systems. It is also contemplated that the mold cavity may be configured to produce a composite of a cylindrical or other shape, thereby reducing or eliminating the need for subsequent machining to form a desired component part.

The slurry, which eventually provides the oxidation protective properties, is prepared with the base medium containing a specific weight percentage of carbon as the percentage of carbon in base medium is a factor in determining what form of carbides are present in the final oxidation resistant coating. The preferred substances which may be used as the base medium of the slurry include phenolic resins, furan, vinylidene chloride, or E-B rubber. The use of the above binders as the base medium of the slurry is advantageous as additives are easily included into the binders for alteration of the oxidation resistant coating.

The solid component of the slurry is a metal silicide, preferably titanium disilicide. It is this metal silicide which provides both the oxidation resisitivity and durability to the carbon composites. Specifically, the metal silicide will upon heating be converted to multiple carbides through chemical reaction with the carbon constituents of the slurry's base medium.

Additionally, other components can be added to the slurry to modify the coatings properties. Boron, specifically boron carbide, is a preferred additive to incorporate into the slurry to increase both the durability of the eventual coating as well as the oxidation protective properties of the coating. Furthermore, boron may also be added as chromium boride to further increase the oxidation protective properties of the coating.

The slurry containing a metal silicide, preferably titanium disilicide, and also any desired additives such as boron carbide or chromium boride, can be applied to the carbon composite in a first coating with a simple brushing technique. This method will provide an even layer of the slurry upon the carbon composite, affording a uniform distribution of metal silicide and carbon-containing medium on the surface of the carbon composite. Once the first coating is brushed upon the carbon composite, additional coatings of the slurry can be applied through either a brushing or spraying technique.

After the substrate carbon composite is coated, the slurry coated substrate carbon foam is heated to about 1500° C., preferably under a vacuum. The presence of oxygen as either carbon monoxide or molecular oxygen is detrimental to the quality of the protective coating by creating oxides within the protective coating. An alternate method of heating the slurry coated substrate carbon foam is to heat the article within an inert environment rather than under a vacuum. Care must be taken in selecting a suitable inert gas as some gases will cause undesirable reactions. Nitrogen, typically considered an atomically inert gas, will react with titanium at elevated temperatures, resulting in a loss of oxidation protection of the carbon composite. Argon is a suitable inert gas for the firing process and minimizes the presence of oxygen, preferably where one repeatedly draws a vacuum with intervening purges of argons.

The above described heating step creates a predominately carbide coating on the surface of the substrate carbon composite and functions as an oxidation protective barrier while being substantially free of phosphorous. Several coating and heat-treating steps may be required to produce the desired coating thickness and surface properties of the oxidation resistant carbon composite. During the heating step, the carbon containing base medium of the slurry pyrolytically decomposes, providing an available carbon source for further chemical reaction with the metal suicide. Dependant upon both the temperature and the available carbon, the metal silicide will react with the carbon to form a possibility of three carbide compounds: a metal carbide, a silicon carbide, and a metal silicide carbide.

Using the preferred titanium disilicide to illustrate, the resultant carbide constituents are dependant upon the available carbon and reaction temperature. Thus, one can tailor both the carbon content of the slurry and the temperature of the conversion reaction to achieve a specifically desired carbide ratio in the protective coating.

Titanium disilicide will react with carbon to form titanium carbide, silicon carbide, or titanium silicon carbide. Through manipulation of the available carbon and careful control of the conversion temperature, the protective coating will be a majority of either titanium carbide and silicon carbide, titanium silicon carbide, or a combination of all three carbides.

Table 1 illustrates the conversion reaction of titanium silicon with carbon as a function of temperature where the carbon is in a similar stoichiometric ratio to the titanium disilicide, such as shown in the following stoichiometric equation.
TiSi₂+1C→xTiC+ySiC+zTi₃SiC₂

Using proportions following the above equation, titanium disilicide powder was mixed with carbon powder and held at the specific temperature for three hours. The resulting phases were determined through x-ray diffraction.

TABLE 1

| | TiSi₂ | C | TiC | SiC | Ti₃SiC₂ |
|---|---|---|---|---|---|
| 1100° C. | ✓ | ✓ | | | |
| 1200° C. | ✓ | ✓ | | | |
| 1300° C. | ✓ | ✓ | Some | | |
| 1400° C. | | | ✓ | ✓ | |
| 1450° C. | | | Trace | Trace | ✓ |
| 1500° C. | | | Trace | Trace | ✓ |
| 1600° C. | | | | | ✓ |

At about 1400° C. the titanium disilicide and carbon powder were virtually completely converted to a matrix of titanium carbide and silicon carbide. Conversely, at about 1600° C. the titanium disilicide and carbon powder were converted into titanium silicon carbide instead of titanium carbide and silicon carbide.

Alternatively, titanium disilicide and carbon can be mixed and heated in the following stoichiometric ratio where there are three carbons for each titanium disilicide.
TiSi₂+3C→xTiC+ySiC+zTi₃SiC₂

Using proportions following the above equation, titanium disilicide powder was mixed with carbon powder following the above chemical equation and held at the specific temperature for three hours. The resulting phases were determined through x-ray diffraction.

TABLE 2

| | TiSi₂ | C | TiC | SiC | Ti₃SiC₂ |
|---|---|---|---|---|---|
| 1100° C. | ✓ | ✓ | | | |
| 1200° C. | ✓ | ✓ | | | |
| 1300° C. | ✓ | ✓ | Trace | Trace | ✓ |
| 1400° C. | | Trace | ✓ | ✓ | ✓ |
| 1450° C. | | Trace | ✓ | ✓ | Trace |
| 1500° C. | | | ✓ | ✓ | |
| 1600° C. | | | ✓ | ✓ | |

As illustrated in Table 2, only titanium carbide and silicon carbide were created from conducting the reaction at 1500° C. or greater whereas with the different stoichiometric ratios, as illustrated in Table 1, titanium silicon carbide is formed at 1500° C. or greater.

Thus, by varying both the ratio of carbon to titanium disilicide and the reaction temperature, the oxidation protective coating can be tailored for both the specific carbon composite and the desired use. For example, with the differing coefficients of thermal expansion for titanium carbide (approximately 7×10⁻⁶° C.⁻¹); silicon carbide (approximately 4×10⁻⁶° C.⁻¹); and titanium silicon carbide (approximately 9×10⁻⁶° C.⁻¹) one can match the thermal expansion characteristics of the carbon composite by manipulating the amounts of titanium carbide, silicon carbide, and titanium silicon carbide present in the oxidation protective coating. Other areas of modification include but are not limited to density, compressive strength, electrical conductivity, and thermal conductivity.

The ratio of carbon to titanium disilicide is controllable through the initial selection of the base medium of the metal silicide-containing slurry. When phenolic resins are utilized as the base medium, the phenolic resin yields approximately 45 weight percent carbon whereas when electron beam(EB) rubber is used as the base medium the EB rubber yields approximately 3.4 weight percent carbon. By careful selection and/or mixing of the two binders a carbon yield can be expected that approximates either a 1TiSi₂:1C ratio or a 1TiSi₂:3C ratio.

In conclusion, the invention allows for carbon composites to operate in highly oxidizable environments which would result in the significant degradation of the carbon composite if not for the oxidation protective coating. Furthermore, it is envisioned that the invention be employed in a variety of applications subjected to oxidizable conditions other than for use as components of high friction braking systems.

Accordingly, by the practice of the present invention, oxidation resistant carbon composites and oxidation protective coatings having heretofore unrecognized characteristics are prepared. These coated carbon composites exhibit good resistance to oxidation in high temperature environments as well as improved durability, making them uniquely effective for applications, such as structural elements of high-friction disc brakes.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for creating an oxidation resistant carbon composite material, which comprises the steps of:
(a) providing a carbon composite material;
(b) applying a metal silicide containing slurry on the surface of the carbon composite material to create a coated carbon composite material; and
(c) heating the coated carbon composite material to convert the slurry coating into an anti-oxidation coating to create an oxidation resistant composite material.

2. The method of claim 1, further comprising repeating step b) and step c) to increase the thickness of the anti-oxidation coating.

3. The method of claim 1, wherein slurry coating contains a base medium selected from the group consisting of phenolic resins, furans, vinylidene cholorides, non-graphitizing polymers, electron beam processed polymers, and combinations thereof.

4. The method of claim 1, wherein the slurry coating of step b) further comprises a boron containing additive.

5. The method of claim 1, wherein the metal silicide of step b) comprises titanium disilicide.

6. The method of claim 1, wherein step (c) includes heating the coated carbon composite of from about 1200° C. to about 1800° C.

7. The method of claim 1, wherein step c) includes heating the coated carbon composite in a vacuum.

8. An oxidation resistant carbon composite material which comprises a carbon composite with an outer coating comprising titanium carbide and silicon carbide.

9. The material of claim 8, wherein the carbon composite is a carbon-carbon composite.

10. The material of claim 8, wherein the carbon composite is a ceramic-carbon composite.

11. The material of claim 8, wherein the coating further comprises a boron carbide.

12. The material of claim 8, wherein the anti-oxidation coating further comprises titanium silicon carbide.

13. The material of claim 8, wherein the coating provides oxidation protection up to about 1800° C.

14. The material of claim 8, wherein the coating provides oxidation protection of from about 800° C. to about 1300° C.

15. A coating providing oxidation protection comprising a mixed layer of titanium carbide and silicon carbide wherein the mixed layer is substantially free of phosphorous.

16. The coating of claim 15, wherein the mixed layer further comprises titanium silicon carbide.

17. The coating of claim 15, wherein the mixed layer further comprises boron carbide.

18. A method for creating an oxidation protective coating, which comprises the steps of:
a) dispersing a metal suicide into a carbon-containing medium to create a metal suicide containing slurry;
b) applying the metal silicide containing slurry to an article requiring oxidation protection; and
c) heating the metal silicide containing slurry of step b) to a temperature sufficient to convert at least a portion of the metal silicide to a metal carbide and silicon carbide.

19. The method of claim 18, wherein the carbon-containing medium is selected from the group consisting of phenolic resins, furans, vinylidene cholorides, non-graphitizing polymers, electron beam processed polymers, and combinations thereof.

20. The method of claim 18 wherein step c) comprises heating the metal silicide containing slurry to a temperature of from about 1000° C. to about 1700° C.

21. The method of claim 18, wherein the metal silicide comprises titanium disilicide.

22. The method of claim 18, wherein the metal silicide containing slurry of step b) further comprises a boron containing additive.

23. A method for creating an oxidation protective coating having selected characteristics, which comprises the steps of:
a) providing a carbon-containing medium having a carbon yield of from about 3.0 wt. % to about 45 wt. %;
b) providing titanium disilicide powder;
c) admixing the titanium disilicide powder and the carbon-containing medium to disperse the titanium suicide into the carbon-containing medium in a stoichiometric ratio of titanium disilicide to carbon yield to create a slurry; and
d) heating the slurry to create an oxidation protective coating wherein the stoichiometric ratio of step c) and temperature of step d) are varied based on the desired selected characteristics.

24. The method of claim 23, wherein the stoichiometric ratio is controlled by the selection of the carbon-containing medium.

25. The method of claim 23, wherein the carbon-containing medium is selected from the group consisting of phenolic resins, furans, vinylidene cholorides, non-graphitizing polymers, electron beam processed polymers, and combinations thereof.

26. The method of claim 23, wherein the stoichiometric ratio of step c) is about 1 titanium disilicide to about 1 carbon.

27. The method of claim 23, wherein the stoichiometric ratio of step c) is about 1 titanium disilicide to about 3 carbons.

28. The method of claim 23, wherein the temperature of step d) is of from about 1000° C. to about 1700° C.
